(19) United States
(12) Patent Application Publication
(10) Pub. No.: US 2017/0075125 A1
(43) Pub. Date: Mar. 16, 2017

(54) RADIO-WAVE TRANSPARENT COVER FOR VEHICLE

(71) Applicant: Hyundai Motor Company, Seoul (KR)

(72) Inventors: Seung Mok Lee, Osan (KR); Young Sub Oh, Suwon (KR); Jin Young Yoon, Gimpo (KR); Bock Cheol Lee, Suwon (KR); Hyun Gyung Kim, Hwaseong (KR); Dong Eun Cha, Suwon (KR)

(21) Appl. No.: 14/956,839

(22) Filed: Dec. 2, 2015

(30) Foreign Application Priority Data
Sep. 11, 2015 (KR) 10-2015-0129038

(51) Int. Cl. G02B 27/22; G09F 3/02; G02B 1/14; B32B 7/12; B32B 27/06; B60R 13/00; G09F 3/10

(52) U.S. Cl. CPC G02B 27/2214; B60R 13/005; G09F 3/02; G09F 3/10; B32B 7/12; B32B 27/06; G02B 1/14; G09F 2003/0202; G09F 2003/023; B32B 2255/10; B32B 2307/412; B32B 2307/418; B32B 2451/00; B32B 2519/00; B32B 2605/08

(57) ABSTRACT

A radio-wave transparent cover of a vehicle is provided. The radio-wave transparent cover includes a design layer that is disposed on the front or rear surface of a film member having improved radio-wave transparency and a design layer that has an image formed thereon. The radio-wave transparent cover further includes a lens layer that is formed on the front surface of the film member and that has protrusions formed thereon, to exhibit exhibiting a metal appearance and effect and that forms a three-dimensional image.

### CROSS REFERENCE TO RELATED APPLICATION

The present application claims priority to Korean Patent Application No. 10-2015-0129038, filed Sep. 11, 2015, the entire contents of which is incorporated herein for all purposes by this reference.

### BACKGROUND OF THE INVENTION

Field of the Invention

The present invention relates to a radio-wave transparent cover for a vehicle, and more particularly, to radio-wave transparency that exhibits a metal appearance and forms a three-dimensional image, using a film having radio-wave transparency and a lens layer and design layer disposed on the front and rear surfaces of the film.

Description of the Related Art

Generally, to improve a vehicle design, the interior components of the vehicle may have various types of images such as a wood pattern, a shell pattern, or a metal appearance (e.g., metallic color). Recently, a high-brightness metallic color has been used for the exterior of the vehicle. According to a conventional method for securing radio-wave transparency and providing a metallic color, a metal film such as indium (In) and tin (Sn) is deposited on the exterior of the vehicle. However, when the metal film such as In and Sn are used, the price of the vehicle increases, and the environment may be polluted by a toxic substance contained within the metal film.

FIG. 1 illustrates a method for manufacturing a conventional radio-wave transparent cover for a vehicle. The radio-wave transparent cover 10 is manufactured using injection molding plastic resin to manufacture a transparent cover 11, and a metal film 12 such as In and Sn is deposited on the interior surface of the transparent cover 11, to secure radio-wave transparency and to provide a metal appearance. A plastic resin 13 is integrally coupled to the rear surface of the transparent cover 11 using insert molding and the radio-wave transparent cover 10 is formed.

However, since the conventional radio-wave transparent cover 10 uses the metal film 12 such as In and Sn, the metal film 12 may significantly increase the cost of the radio-wave transparent cover 10, and contribute to environmental pollution. Furthermore, the conventional radio-wave transparent cover 10 provides a metallic color (e.g. metal appearance, look or effect) and does not create a three-dimensional image, and the merchantability thereof may be degraded.

The foregoing is intended merely to aid in the understanding of the background of the present invention, and is not intended to mean that the present invention falls within the purview of the related art that is already known to those skilled in the art.

### SUMMARY OF THE INVENTION

The present invention provides a radio-wave transparent cover that has improved radio-wave transparency, exhibits a metal appearance and effect, and forms a three-dimensional image, using a film having improved radio-wave transparency. Further, a lens layer and a design layer may be formed on the front and rear surfaces of the film, and may reduce the cost and prevent environmental pollution since a metal film (e.g., In or Sn) is omitted.

According to one aspect of an exemplary embodiment, a radio-wave transparent cover for a vehicle may include a film member having a resin layer for adjusting a penetration ratio and refractive index with respect to penetrating visible line. Further included may be a design layer disposed on the front or rear surface of the film member and having a specific image formed thereon through printing or deposition and a lens layer disposed on the front surface of the film member that transforms the image formed on the design layer into a three-dimensional image.

The radio-wave transparent cover may further include a cover layer coupled to the front surface of the lens layer to protect the lens layer and provide a uniform (e.g., standardized) thickness. Additionally, a base layer may be coupled to the rear surface of the film member to protect the film member and may provide a uniform thickness, when the design layer is disposed on the front surface of the film member. Another, a base layer may be coupled to the rear surface of the design layer to protect the design layer and provide a uniform thickness, when the design layer is disposed on the rear surface of the film member.

The film member may include a single resin layer or a plurality of resin layers. The radio-wave transparent cover may further include an adhesive layer disposed between the lens layer and the cover layer to couple the lens layer and the cover layer, and may increase the effect of the three-dimensional image created by the lens layer. The image may be formed on the surface of the design layer adjacent to the film member through any one of printing, painting, deposition, and transfer. The design layer may be a translucent or opaque resin.

The lens layer may be formed on the surface of the uppermost layer of the film member adjacent to the cover layer, and may have a plurality of minute protrusions that extend toward the cover layer. The cover layer may be a transparent injection-molded resin. The base layer may be a translucent or opaque injection-molded resin and adhesive layer may be a transparent material.

According to an exemplary embodiment of the present invention the radio-wave transparent cover may include the lens layer and the design layer formed on the film member and may have improved radio-wave transparency, and create a three-dimensional image while exhibiting a metal look effect, thereby improving the merchantability of products. Furthermore, as a metal layer such as In or Sn is not used, the cost may be reduced, and environmental pollution may be prevented.

### BRIEF DESCRIPTION OF THE DRAWINGS

The above and other objects, features and other advantages of the present invention will be more clearly understood from the following detailed description when taken in conjunction with the accompanying drawings:

FIG. 1 is an exemplary diagram for describing a conventional radio-wave transparent cover according to the related art;

FIG. 2 is an exemplary diagram for describing a radio-wave transparent cover according to an exemplary embodiment of the present invention;

FIG. 3 is an exemplary diagram for describing a radio-wave transparent cover according to another exemplary embodiment of the present invention;

FIG. 4 is an exemplary diagram for describing a film member used in the exemplary embodiment of the present invention;

FIG. 5 is an exemplary diagram for describing a design layer used in the exemplary embodiment of the present invention; and

FIG. 6 is an exemplary diagram illustrating a three-dimensional image created by the radio-wave transparent cover according to the exemplary embodiment of the present invention.

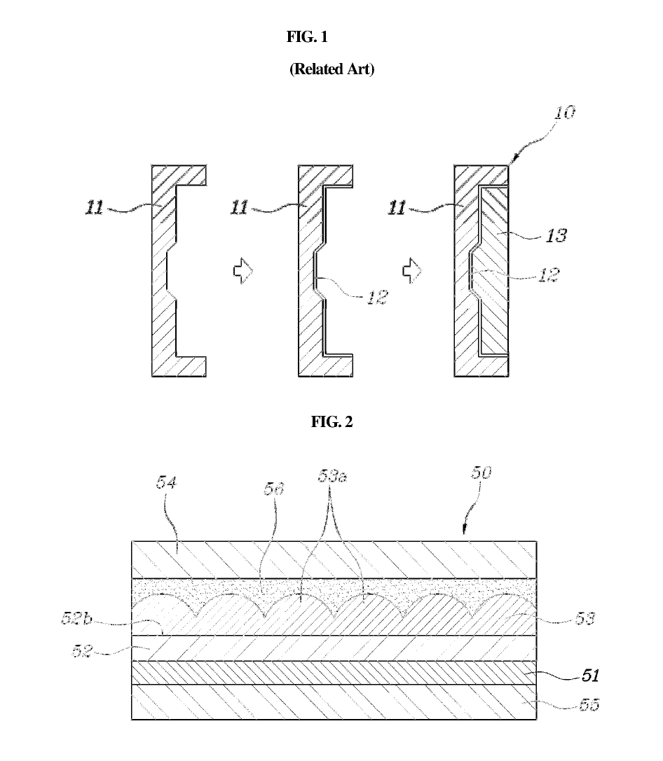

### DETAILED DESCRIPTION OF THE INVENTION

Hereinafter, a radio-wave transparent cover for a vehicle according to an embodiment of the present invention will be described with reference to the attached drawings. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

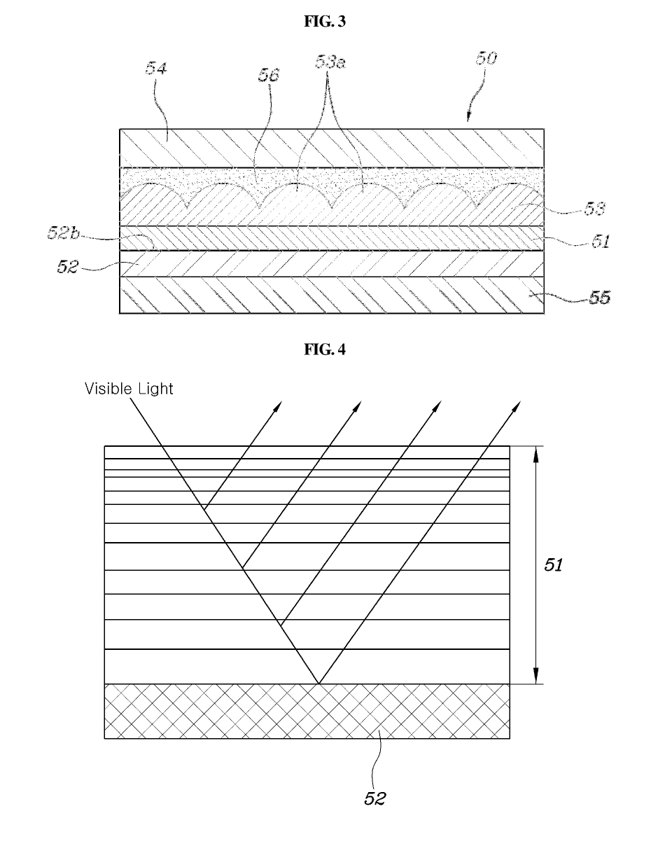

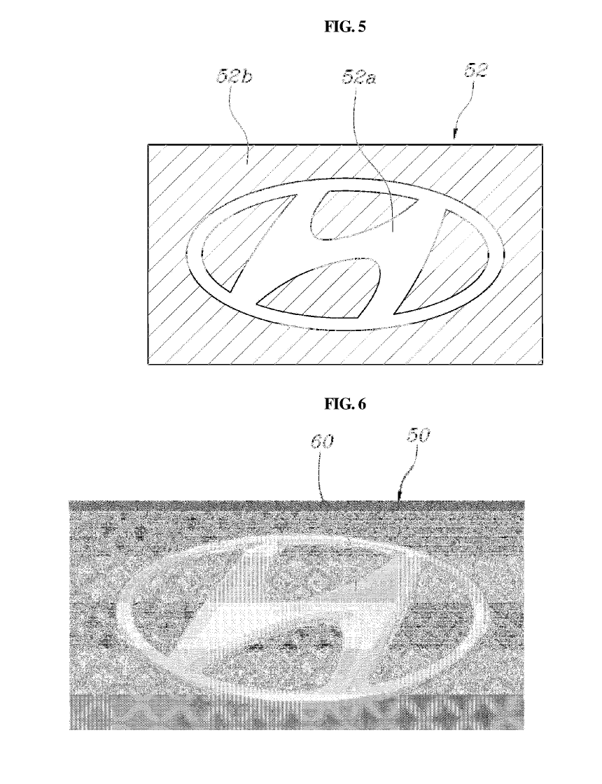

As illustrated in FIGS. 2 to 6, a radio-wave transparent cover 50 for a vehicle according to an exemplary embodiment of the present invention may include a film member 51 having resin layers that adjust a penetration ratio and refractive index with respect to penetrating visible light, a design layer 52 disposed (e.g., stacked) over the film member 51 and having an image (e.g., a specific image) 52a formed thereon through printing or deposition, and a lens layer 53 disposed on the front surface of the film member 51 to transform the image (e.g., a specific image) 52a formed on the design layer 52 into a three-dimensional image 60.

The resin layers that form the film member 51 may be formed of high refractive index polymer and low refractive index polymer. Each resin layer may exhibit or demonstrate improved formability while having a high degree of brightness and natural metallic color. Furthermore, the resin layers may maintain the metallic color without delamination even after forming, and may have improved (e.g., excellent) radio-wave transparency. Since the film member 51 is described in more detail is shown in the related art Korean Patent Publication No. 10-2008-0034899, the detailed descriptions thereof are omitted herein. The film member 51 may be a transparent material.

The radio-wave transparent cover according to the exemplary embodiment of the present invention may further include a cover layer 54 coupled to the front surface of the lens layer 53 to protect the lens layer 53 and to provide a uniform thickness, a base layer 55, and an adhesive layer 56 disposed between the lens layer 53 and the cover layer 54 to couple the lens layer 53 and the cover layer 54 and may increase the effect of the three-dimensional image 60 created by the lens layer 53. The cover layer 54 may be a transparent injection-molded resin, the base layer 55 may be translucent or opaque injection-molded resin, and the adhesive layer 56 may be a transparent material. In the exemplary embodiment of the present invention, the design layer 52 may be disposed on the front surface of the film member 51 as illustrated in FIG. 2. In other words, the base layer 55 may be coupled to the rear surface of the film member 51, and may protect the film member 51 and provide a uniform thickness.

In another exemplary embodiment of the present invention, the design layer 52 may be disposed on the rear surface of the film member 51 as illustrated in FIG. 3. In particular, the base layer 55 may be coupled to the rear surface of the design layer 52, and may protect the design layer 52 and may provide a uniform thickness. The image 52a formed on the design layer 52 may include a symbol or logo that has no three-dimensional effect. The image 52a may be disposed on the surface 52b of the design layer 52 by any one of printing, painting, deposition, and transfer. The design layer 52 may reflect visible light that passes through the film member 51 and provides a metal appearance (e.g., effect) by the reflection of the visible light. The design layer 52 may be a translucent or opaque resin to display the specific image disposed on the surface 52b.

The lens layer 53 may be disposed on the surface of the uppermost layer of the film member 51 adjacent to the cover layer 54, and may include a plurality of minute protrusions 53a that extend toward the cover layer 54. In other words, the plurality of minute protrusions 53a may be disposed on the surface of the uppermost layer of the film member 51, thereby forming the lens layer 53. The protrusions 53a of the lens layer 53 may have the shape of a convex lens, and may refract visible light reflected by the design layer 52 to transform the image 52a of the design layer 52 into the three-dimensional image 60 illustrated in FIG. 6. In particular, depth perception may be provided through the transparent layer of the film member 51. For example, the lens layer 53 and the three-dimensional image 60 may provide depth perception. Further, to increase the effect of the three-dimensional image 60 formed by the lens layer 53, the adhesive layer 56 may be applied uniformly into gaps between the protrusions 53a.

In the radio-wave transparent cover according to an exemplary embodiment of the present invention, the image 52a having no three-dimensional effect may be disposed on the design layer 52 that may be positioned on the front or rear surface of the film member 51 and may provide improved radio-wave transparency. Additionally, the lens layer 53 having the protrusions 53a formed thereon may be disposed on the front surface of the film member 51 or on the front surface of the design layer 52. Accordingly, the radio-wave transparent cover may have improved radio-wave transparency, may provide a metal appearance through the design layer 52, and may form the three-dimensional image 60 through the lens layer 53 that includes the protrusions 53a formed thereon, thereby improving the merchantability.

Furthermore, a metal layer that includes In and Sn used to provide a metal appearance and effect may be omitted unlike the conventional radio-wave transparent cover. Accordingly, the cost may be significantly reduced, and environmental pollution may be prevented. Examples of the radio-wave transparent cover for a vehicle may include a smart cruise control sensor cover and various other sensor covers.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A radio-wave transparent cover for a vehicle, comprising:
a film member having a resin layer for adjusting a penetration ratio and refractive index with respect to penetrating visible line;
a design layer disposed on the front or rear surface of the film member and having an image formed thereon through printing or deposition; and
a lens layer disposed on the front surface of the film member and transforms the image formed on the design layer into a three-dimensional image.

2. The radio-wave transparent cover according to claim 1, further comprising:
a cover layer coupled to the front surface of the lens layer to protect the lens layer and having a uniform thickness.

3. The radio-wave transparent cover according to claim 1, further comprising:
a base layer coupled to the rear surface of the film member to protect the film member and having a uniform thickness, when the design layer is disposed on the front surface of the film member.

4. The radio-wave transparent cover according to claim 1, further comprising:
a base layer coupled to the rear surface of the design layer to protect the design layer and having a uniform thickness, when the design layer is disposed on the rear surface of the film member.

5. The radio-wave transparent cover according to claim 1, wherein the film member includes a single resin layer or a plurality of resin layers.

6. The radio-wave transparent cover according to claim 2, further comprising:
an adhesive layer disposed between the lens layer and the cover layer to couple the lens layer and the cover layer, and increases the effect of the three-dimensional image formed by the lens layer.

7. The radio-wave transparent cover according to claim 1, wherein the image is formed on the surface of the design layer facing the film member through any one of printing, painting, deposition, and transfer.

8. The radio-wave transparent cover according to claim 1, wherein the design layer is a translucent or opaque resin.

9. The radio-wave transparent cover according to claim 2, wherein the lens layer is formed on the surface of the uppermost layer of the film member facing the cover layer, and has a plurality of minute protrusions that extend toward the cover layer.

10. The radio-wave transparent cover according to claim 2, wherein the cover layer is a transparent injection-molded resin.

11. The radio-wave transparent cover according to claim 3, wherein the base layer is a translucent or opaque injection-molded resin.

12. The radio-wave transparent cover according to claim 6, wherein the adhesive layer is a transparent material.
